(19) United States
(12) Patent Application Publication
(10) Pub. No.: US 2020/0407063 A1
(43) Pub. Date: Dec. 31, 2020

(54) AIRCRAFT OCCUPANT RESTRAINT PRETENSIONING SYSTEMS, AND ASSOCIATED DEVICES AND METHODS

(71) Applicant: AmSafe, Inc., Phoenix, AZ (US)

(72) Inventor: Bradley Scott Walker, Gilbert, AZ (US)

(21) Appl. No.: 16/453,210

(22) Filed: Jun. 26, 2019

(51) Int. Cl. B64D 11/06; B64D 25/06

(52) U.S. Cl. CPC B64D 11/062; B64D 25/06

(57) ABSTRACT

Web pretensioning system devices for increasing the amount of web retracted by a given pretensioning stroke are disclosed. In some embodiments, the disclosed web pretensioning systems can include a pretension multiplier configured to receive a web of an aircraft passenger seat occupant restraint system. The pretension multiplier can include a web guide and a web coupling that is operably connected to a pretensioner. In operation, the pretensioner rapidly pulls or otherwise moves the web coupling away from the web guide a first distance, thereby retracting a loop of the web through the web guide. As a result of retracting the loop of web through the web guide, the overall retracted length of the web is equal to a second distance that is greater than the first distance.

### TECHNICAL FIELD

The present disclosure is generally related to vehicle occupant restraint systems and, more particularly, to pretensioning systems for use with aircraft occupant restraint systems.

### BACKGROUND

Occupant restraint systems for use in commercial aircraft must meet federal safety requirements; including the requirements set forth in 14 C.F.R. § 25.562, which is incorporated herein by reference in its entirety. To meet these requirements, passenger seats in commercial aircraft typically include two-point restraint systems, and sometimes three-point restraint systems, to secure occupants in their seats during an emergency landing or other accident event. In some instances, two-point restraints have been used with pretensioners to reduce forward head excursion of occupants in forward-facing or oblique seats during an accident or other rapid deceleration event. Conventional pretensioners rapidly retract a portion of the seat belt and tighten it before the full impact of a crash or similar event is experienced by the seat occupant. Such pretensioning devices and systems are disclosed in U.S. patent application Ser. No. 14/565,207, which was filed Dec. 9, 2014, is titled “AIRCRAFT OCCUPANT RESTRAINT PRETENSIONING DEVICES, SYSTEMS AND METHODS,” and is incorporated herein by reference in its entirety.

Additionally, some three-point restraint systems have also been used with pretensioners to reduce forward head excursion during an accident event. Some of these systems have consisted of a specially designed inertia reel that incorporates a pretensioner. When activated (in response to, e.g., a rapid deceleration), the pretensioner rapidly winds the inertia reel and retracts the slack in the seat belt web. Examples of such systems are disclosed in U.S. patent application Ser. No. 15/476,315, which was filed Mar. 31, 2017, is titled “PRETENSIONER FOR RETRACTABLE SHOULDER BELT AND SEAT BELT,” and is also incorporated herein by reference in its entirety. Other known pretensioning systems include a linear pretensioner having a cable that is attached to the inertia reel. When activated, the pretensioner rapidly retracts the cable and pulls the inertia reel downward on a track, causing the inertia reel to lock and remove slack in the seat belt web.

Reducing forward head excursion during an accident event can allow airlines to place passenger seats closer to potential head strike obstacles, while still maintaining enough distance so that there is no passenger contact with the head strike obstacle in the event of an accident event. Placing seats closer together in this manner can enable airlines to provide additional passenger seats, such as an additional row of passenger seats. Accordingly, it would be advantageous to provide aircraft occupant restraints with improved systems for reducing forward occupant head excursion in forward-facing, oblique-facing, and/or other seating arrangements.

### BRIEF DESCRIPTION OF THE DRAWINGS

FIG. 1A is a partially schematic side view of an occupant restraint system having a pretensioning system configured in accordance with some embodiments of the present technology, FIG. 1B is a partially schematic front view of the occupant restraint system, and FIG. 1C is a partially schematic rear view of the occupant restraint system.

FIG. 2A is a front isometric view of an occupant restraint pretensioning system having a pretension multiplier configured in accordance with some embodiments of the present technology in a first state of operation, and FIG. 2B is a front isometric view of the pretensioning system in a second state of operation.

FIG. 3A is an exploded front isometric view of the pretension multiplier of FIGS. 2A and 2B, and FIG. 3B is a partially assembled front isometric view of the pretension multiplier.

FIG. 4A is a side cross-sectional view of the pretension multiplier of FIGS. 2A-3B in a first state of operation, and FIG. 4B is a side cross-sectional view of the pretension multiplier in a second state of operation, in accordance with some embodiments of the present technology.

FIG. 5A is a front isometric view of an occupant restraint pretensioning system having a pretension multiplier configured in accordance with other embodiments of the present technology, and FIG. 5B is a rear isometric view of the pretensioning system of FIG. 5A.

FIG. 6A is an exploded rear isometric view of the pretension multiplier of FIGS. 5A and 5B, FIG. 6B is a partially assembled rear isometric view of the pretension multiplier, and FIG. 6C is a partially assembled rear isometric view of the pretension multiplier with a web of the occupant restraint installed thereon, in accordance with some embodiments of the present technology.

FIG. 7A is a side cross-sectional view of the pretension multiplier of FIGS. 5A-6B in a first state of operation, and FIG. 7B is a side cross-sectional view of the pretension multiplier in a second state of operation, in accordance with some embodiments of the present technology.

FIGS. 8A and 8B are partially schematic, partially cross-sectional front views of the pretensioning system of FIGS. 2A and 2B in first and second states of operation, in accordance with some embodiments of the present technology.

### DETAILED DESCRIPTION

The following disclosure describes various embodiments of web pretensioning systems for reducing forward head excursion of occupants in passenger seats in aircraft and other vehicles. In some embodiments, web pretensioning systems configured in accordance with the present disclosure can include a pretensioner having a cable that is operably coupled to a device for increasing the amount of web pretension that would otherwise be provided by the pretensioner without the device. For ease of reference, such devices may be referred to herein as “pretension multipliers.” For example, as described in greater detail below, in some embodiments pretension multipliers configured in accordance with the present disclosure can include a web coupling that is configured to slidably engage the web, and a web guide configured to slidably support the web. In operation, activation of the pretensioner (in response to, e.g., an accident or other rapid deceleration event) causes the pretensioner to rapidly retract the cable and pull the web coupling away from the web guide, thereby pulling a loop of the web through the web guide that is greater in length than the retracted length of the pretensioner cable. In some embodiments, the web guide can include a first guide member positioned on one side of the web coupling and a second guide member positioned on the opposite side of the web coupling. Each of the guide members can include a web bearing surface configured to support the web as it slides or otherwise passes back and forth through the pretension multiplier in use. Similarly, the web coupling can also include a web bearing surface configured to pull a loop of the web through the web guide in response to activation of the pretensioner. By pulling a loop of the web through the web guide in the foregoing manner, the pretension multiplier can effectively increase the length of web (by, e.g., about 50% to about 90%, or about 66%) that would otherwise be retracted by the pretensioner without the pretension multiplier.

Although embodiments of the present technology are described herein in the context of aircraft occupant restraint systems (e.g., commercial airline occupant restraint systems) for use in forward-facing seats, oblique seats, side-facing seats, etc., those of ordinary skill in the art will understand that the various systems, apparatuses, and methods described herein can also be used in other types of vehicles, including other types of aircraft (e.g., private aircraft, helicopters, etc.), land vehicles, etc. Accordingly, aspects and embodiments of the present disclosure are not limited to use in airplanes or other aircraft.

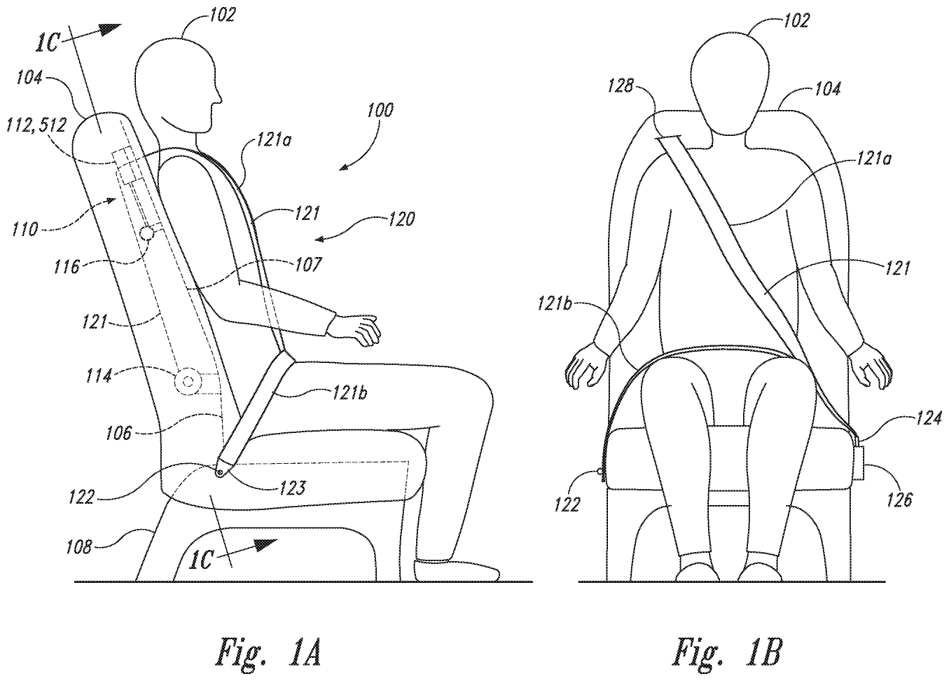

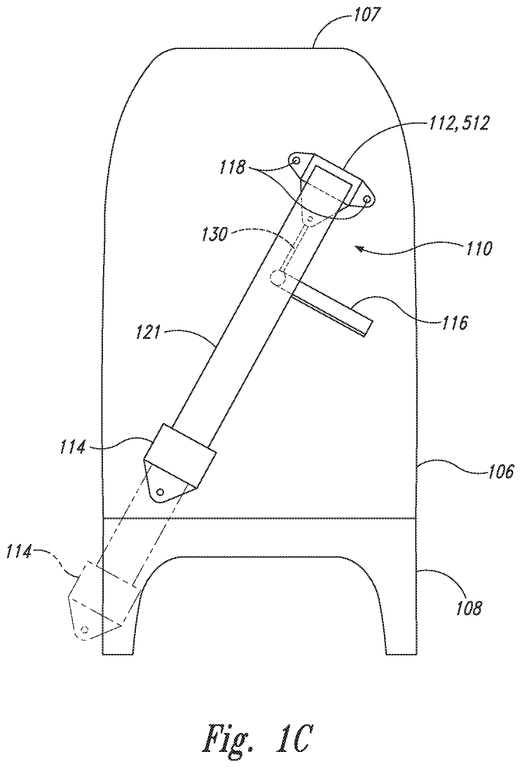

Certain details are set forth in the following description and in FIGS. 1A-8B to provide a thorough understanding of various embodiments of the present technology. In other instances, well-known structures, materials, operations and/or systems often associated with occupant restraint systems, web pretensioners, aircraft seats, seat belts, crash sensing systems, pretensioner activation systems, etc. are not shown or described in detail in the following disclosure to avoid unnecessarily obscuring the description of the various embodiments of the technology. Those of ordinary skill in the art will recognize, however, that the present technology can be practiced without one or more of the details set forth herein, or with other structures, methods, components, and so forth.

The accompanying Figures depict embodiments of the present technology and are not intended to be limiting of its scope. The sizes of various depicted elements are not necessarily drawn to scale, and these various elements may be arbitrarily enlarged to improve legibility. Component details may be abstracted in the Figures to exclude details such as position of components and certain precise connections between such components when such details are unnecessary for a complete understanding of how to make and use the invention.

Many of the details, dimensions, angles and other features shown in the Figures are merely illustrative of some embodiments of the disclosure. Accordingly, other embodiments can have other details, dimensions, angles and features without departing from the spirit or scope of the present invention. In addition, those of ordinary skill in the art will appreciate that further embodiments of the invention can be practiced without several of the details described below. In the Figures, identical reference numbers identify identical, or at least generally similar, elements. To facilitate the discussion of any particular element, the most significant digit or digits of any reference number refers to the Figure in which that element is first introduced. For example, element 110 is first introduced and discussed with reference to FIG. 1.

FIG. 1A is a partially schematic side view of an occupant restraint system 100 having a pretensioning system 110 with a pretension multiplier 112 configured in accordance with some embodiments of the present technology. FIG. 1B is a partially schematic front view of the occupant restraint system 100, and FIG. 1C is a partially schematic rear view of the occupant restraint system 100 taken along line 1C-1C in FIG. 1A. Referring first to FIGS. 1A and 1B together, in the illustrated embodiment, the restraint system 100 includes a three-point restraint 120 configured to secure an occupant 102 in a seat 104. The seat 104 can be an aircraft passenger seat in, e.g., a commercial passenger jet or other passenger aircraft. In some embodiments, the seat 104 can be a forward-facing seat in which the seat 104 and the occupant 102 are facing forward (i.e., parallel to the longitudinal axis of the aircraft and toward the direction of flight or forward motion). In other embodiments, the seat 104 can be an oblique seat in which the occupant 102 and the seat 104 are positioned at an angle relative to the longitudinal axis of the aircraft and the direction of forward motion. For example, in some embodiments, the seat 104 can be positioned at an angle ranging from about 10 degrees to about 80 degrees, or about 30 degrees relative to the longitudinal axis of the aircraft. In other embodiments, the seat 104 can be a side-facing seat in which the occupant 102 and the seat 104 are facing perpendicular, or at least generally perpendicular, to the longitudinal axis of the aircraft and the direction of forward motion. Although the foregoing describes various seat arrangements that can be used with the pretensioning technology described herein, in other embodiments, the pretensioning systems described herein can be used with other seating arrangements and/or other vehicles and are not limited to any particular seating arrangement or vehicle unless expressly set forth herein.

In the illustrated embodiment, the three-point restraint 120 includes an elongate and flexible web 121 having a first web portion (e.g., a shoulder web portion 121a) and a second web portion (e.g., a lap web portion 121b). The proximal end of the lap web portion 121b can be fixedly attached to an anchor point 122 on a first portion of a seat frame 106 (e.g., a seat base portion 108) by means of a suitable end fitting 123. The shoulder web portion 121a passes through an opening 128 in an upper portion the seat 104 and is operably coupled to a web retractor 114 mounted to a second portion of the seat frame 106 (e.g., a lower portion of a seat back portion 107). In some embodiments, the web retractor 114 (which can also be referred to as an inertia reel) can be a conventional web retractor having a spring driven spool around which is wound the end portion of the shoulder web portion 121a. The web retractor 114 can be configured to apply tension to the web 121 and retract slack in the web 121 during use to automatically adjust the fit of the web 121 in response to movement of the occupant 102 and/or the aircraft, Additionally, the web retractor 114 can be configured to lock in the event that a rapid tension load is applied to the web 121 as a result of, for example, the occupant 102 pitching forward rapidly in response to an accident event or other rapid deceleration of the aircraft. Accordingly, unless otherwise specified herein, the web retractor 114 can be any conventional web retractor known to those of ordinary skill in the art.

In the illustrated embodiment, the three-point restraint 120 further includes a web connector 124 that can be slidably carried by the web 121 and configured to be releasably engaged with a buckle 126, which can in turn be fixedly attached to the seat frame 106 opposite the anchor point 122. The buckle 126 can be configured to receive and releasably engage the web connector 124 to secure the three-point restraint 120 about occupant 102 in a conventional manner. When the seat occupant 102 desires to get out of the seat 104, the occupant 102 can release the web connector 124 by, e.g., lifting a cover on the buckle 126 or depressing a button on the buckle 126 in a conventional manner.

As used herein, the term “web” can generally refer to any type of flexible strap or belt, such as a conventional seat belt web made from woven material (e.g., woven nylon) as is well known in the art for use with personal restraint systems. The web 121 can include flexible segments of a fixed length and/or an adjustable length to accommodate different sized occupants. In other embodiments, end portions of the web 121 can be releasably coupled together and/or around the occupant 102 in other arrangements using releasable coupling devices well known in the art, including, e.g., “lift-latch” buckles, “press-release” buckles, etc. Although some embodiments of the present technology include use of a web retractor (e.g., the web retractor 114), in other embodiments, the associated end portion of the web 121 can be fixed directly to the seat frame 106 or other structure (e.g., an adjacent portion of the airframe) and/or the web 121 can be manually adjustable (e.g., with a web adjustor, etc.) to adjust the fit of the web 121 around the occupant 102.

Referring next to FIGS. 1A and 1C together, the pretensioning system 110 further includes a pretensioner 116 that is operably coupled to the pretension multiplier 112 by means of a connecting member 130 (e.g., a cable, a lead wire, etc.). As described in greater detail below, in some embodiments, the pretensioner 116 can be a conventional linear pretensioner configured to rapidly retract the cable 130 in response to an electrical signal indicating a crash event or other rapid deceleration above a preset magnitude. In other embodiments, the pretensioner 116 can be a rotary pretensioner or other suitable device or actuator for rapidly retracting the cable 130 in response to detection or sensing of a dynamic event above a preset magnitude. Both the pretensioner 116 and the pretension multiplier 112 can be fixedly attached to the seat back portion 107 of the seat frame 106 with suitable fasteners, e.g., bolts, screws, etc. For example, in the illustrated embodiment, the pretension multiplier 112 is fixedly attached to the seat back portion 107 with a pair of fasteners 118 (e.g., bolts).

As illustrated in FIG. 1C, in some embodiments, the web retractor 114 can be fixedly attached to the seat back portion 107 with one or more suitable fasteners (e.g., bolts) in a conventional manner. In other embodiments, the web retractor 114 can be mounted to other portions of the seat frame 106, such as the seat base portion 108 (as shown by broken lines in FIG. 1C) or to an adjacent mounting point on the aircraft structure (e.g., on a portion of the aircraft cabin wall, floor, etc.).

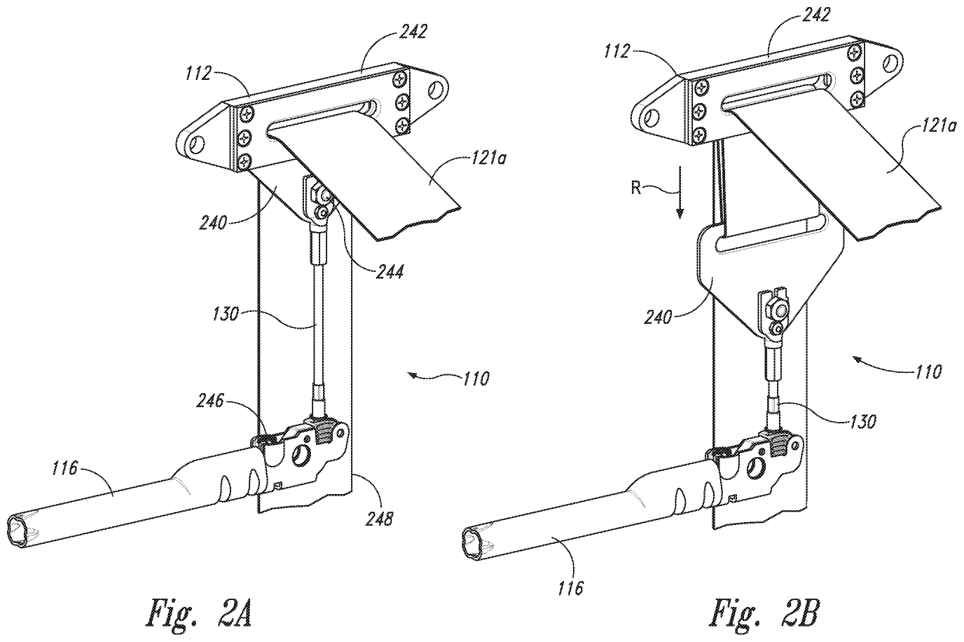

FIGS. 2A and 2B are front isometric views of the pretensioning system 110 in two different stages of operation, in accordance with some embodiments of the present technology. Referring first to FIG. 2A, the pretension multiplier 112 includes a web guide 242 and a web coupling 240. The web coupling 240 is operably coupled to the pretensioner 246 by means of the cable 130. The cable 130 can be fixedly attached to the web coupling 240 by means of a suitable fastener 244 (e.g., a bolt). As this view illustrates, the shoulder web portion 121a passes through the pretension multiplier 112 and then extends downwardly so that an end portion 248 of the shoulder web portion 121a can be coupled to the retractor 114 (FIG. 1C). Prior to activation of the pretensioning system 110, the shoulder web portion 121a is able to slide back and forth through the pretension multiplier 112 as the web retractor 114 takes in and pays out portions of the web 121 in use.

FIG. 2B illustrates the pretensioning system 110 after activation of the pretensioner 116. As this view illustrates, upon activation, the pretensioner 116 rapidly retracts the cable 130 and pulls the web coupling 240 downwardly in direction R toward the pretensioner 116. As described in greater detail below, as the web coupling 240 moves downwardly, it pulls a loop of the shoulder web portion 121a through the web guide 242, thereby retracting an overall length of the web 121 that is greater than the distance traveled by the web coupling 240.

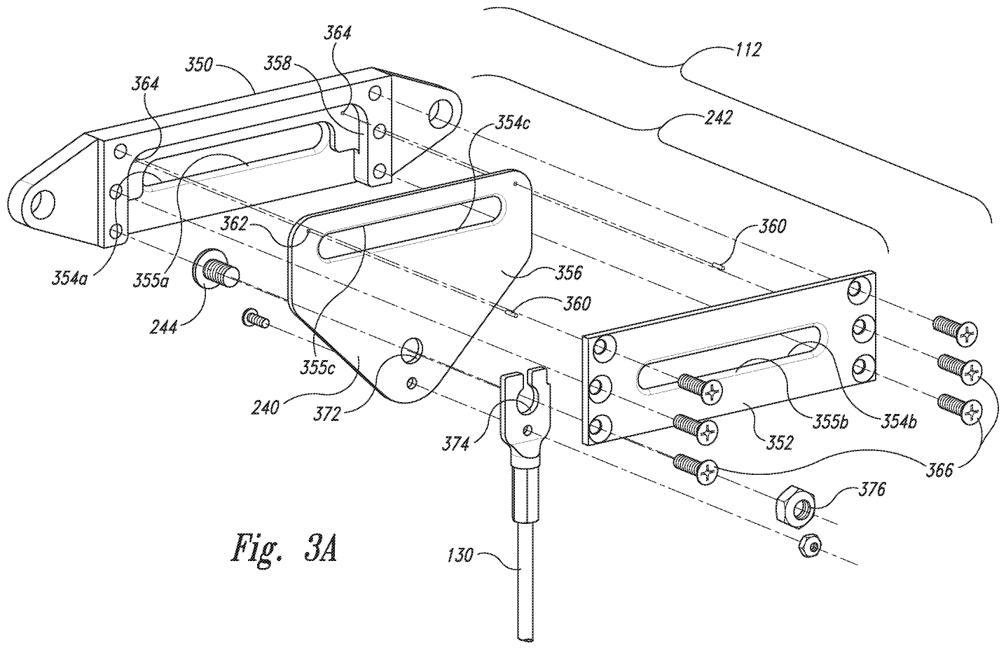

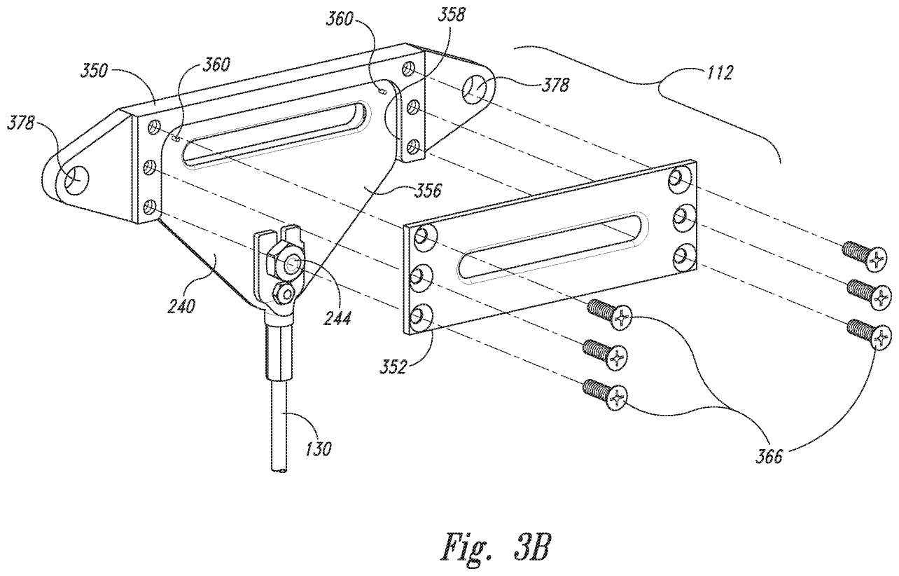

FIG. 3A is an exploded front isometric view of the pretension multiplier 112 configured in accordance with some embodiments of the present technology, and FIG. 3B is a partially assembled front isometric view of the pretension multiplier 112. Referring first to FIG. 3A, in the illustrated embodiment, the web guide 242 includes a first web guide member 350 having a first web aperture 354a and a second web guide member 352 having a second web aperture 354b. The first web aperture 354a includes a first web sliding surface or bearing surface 355a, and the second web aperture 354b similarly includes a second web bearing surface 355b. The first guide member 350 can further include one or more fastener holes 378 on opposite ends thereof to receive the fasteners 118 for fixedly attaching the web guide 242 to the seat back portion 107 of the seat frame 106 (FIG. 1C). The web coupling 240 includes a web coupling member 356 having an upper portion configured (e.g., shaped and sized) to be received in a pocket or recess 358 formed in the first web guide member 350. The web coupling member 356 includes a third web aperture 354c having a third web bearing surface 355c. As noted above, the cable 130 can be fixedly attached to the web coupling member 356 by means of a fastener 244 (e.g., a bolt) that extends through a first fastener hole 372 in the coupling member 356 and a corresponding second fastener hole 374 and an end fitting 375 of the cable 130 before engaging a suitable nut 376. In some embodiments, the first web guide member 350, the second web guide member 352, and the web coupling member 356 can be formed from a metal, such as aluminum, that is machined or otherwise formed to shape using conventional methods known in the art, and the bearing surfaces 355a-c can be smooth (e.g., rounded) surfaces that enable the web 121 to slide thereon with relatively low friction and without sustaining damage. In other embodiments, the first guide member 350, the second guide member 352, and the web coupling member 356 can be formed from other suitable materials known in the art, including other metals, composites, etc.

Referring next to FIGS. 3A and 3B together, the coupling member 356 can be releasably secured in the recess 358 in the first guide member 350 by means of one or more frangible pins 360 (e.g. two pins 360) which extend through first pin holes 362 in the coupling member 356 and into corresponding second pin holes 364 in the first guide member 350 (FIG. 3A). The frangible pins 360 can be configured (e.g., sized and shaped) to retain the coupling member 356 in the recess 358 under normal operating conditions of the restraint system 100, but configured to break and release the coupling member 356 in response to the pull force exerted on the coupling member 356 by the cable 130 in response to activation of the pretensioner 116. In some embodiments, the pins 360 can be made from a metal, such as aluminum, or a non-metal, such as Delrin, nylon, plastic, etc., of suitable diameter. Although the frangible pins 360 can be used in some embodiments, in other embodiments, other means of releasably holding the web coupling member 356 in the recess 358 can be used, including other types of releasable fasteners, adhesives, etc.

Once the coupling member 356 has been releasably secured in the recess 358, the second guide member 352 can be fastened to the first guide member 350 by a plurality of fasteners, such as machine screws 366. When fully assembled, the first, second, and third web apertures 354a, b, and c are aligned, or at least approximately aligned, as shown in FIG. 2A so that the web 121 (or, more particularly, the shoulder web portion 121a) can slide freely through the web apertures 354a-c during use of the three-point restraint 120 (FIG. 1A).

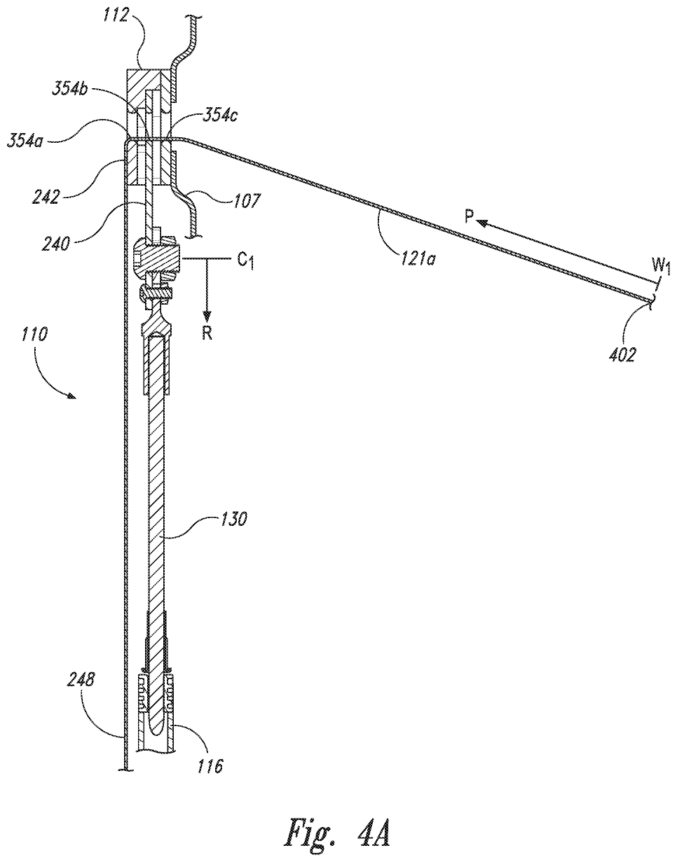

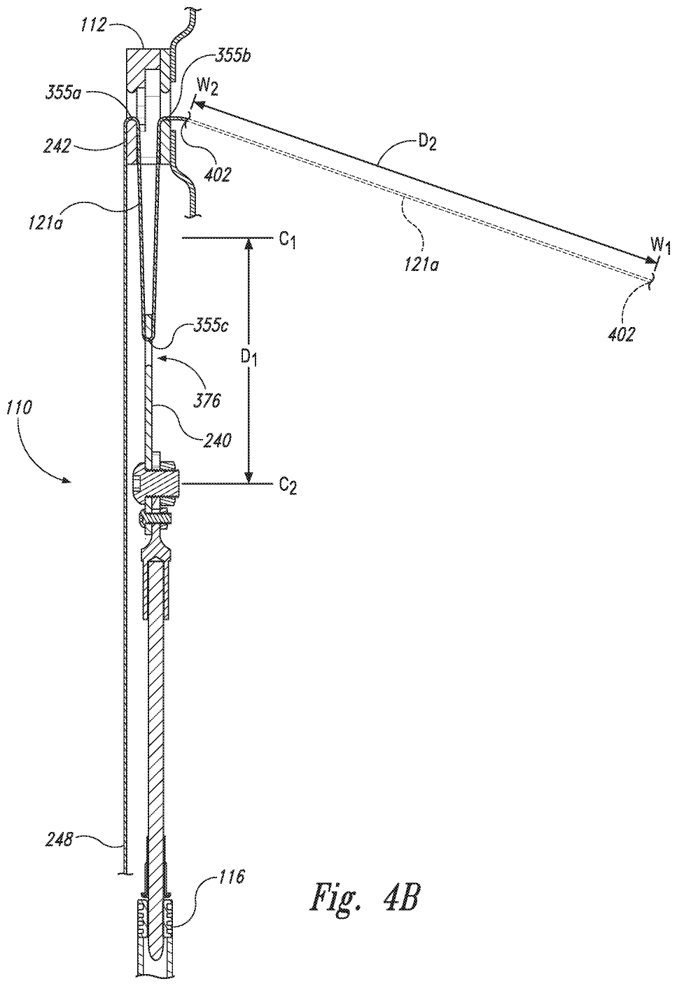

FIGS. 4A and 4B are side cross-sectional views of the pretension multiplier 112 in two states of operation, in accordance with some embodiments of the present technology. Referring first to FIG. 4A, in this view the pretensioner 116 has not been activated and, as a result, the web coupling 240 is retained by the web guide 242 so that each of the web apertures 354a-c are aligned, or at least approximately aligned. Referring next to FIGS. 4A and 4B together, when the pretensioner 116 is activated in response to, e.g., a crash event or other rapid deceleration above a preset magnitude, it exerts a force on the web coupling 240 via the cable 130 in direction R. This force breaks the frangible pins 360 (FIG. 3A) and pulls the web coupling 240 rapidly downwardly in direction R from a first coupling position C₁ toward a second coupling position C₂. As the shoulder web portion 121a starts to move, the rapid tension force in the web causes the web retractor 114 (FIG. 1C) to lock the end portion 248 of the shoulder web portion 121a in position. Continued downward movement of the web coupling 240 pulls a loop of the shoulder web portion 121a through the web guide 242, as shown in FIG. 4B. More specifically, when the web coupling 240 moves from the first coupling position C to the second coupling position C₂, it moves through a first distance D₁. By way of example, this causes a reference point 402 on the shoulder web portion 121a to move in direction P from a first web position W₁ to a second web position W₂, through a second distance D₂. Because the web coupling 240 pulls a loop of the shoulder web portion 121a through the web guide 242, downward movement of the web coupling 240 over the first distance D₁ retracts the shoulder web portion 121a through the second distance D₂, which is greater than the first distance D₁. Thus, use of the pretension multiplier 112 in the foregoing manner can increase or “multiply” the amount of web that is retracted by a given stroke of the pretensioner 116. For example, in some embodiments, the first distance D₁ can be equal to 3 inches, or about 3 inches, and the second distance D₂ can be equal to 5 inches, or about 5 inches. In some embodiments, the second distance D₂ can range from about 1.2 to about 2 times the first distance D₁, or from about 1.4 to about 1.9 times the first distance D₁.

As shown in FIG. 4B, when the web coupling 240 moves downwardly in the direction R, the first and second web bearing surfaces 355a and 355b bear against one side (e.g., an underside) of the shoulder web portion 121a, while the third web bearing surface 355c bears against the opposite side (e.g., an upper side) of the shoulder web portion 121a. More specifically, in some embodiments, the end portion 248 of the web 121 will remain locked by means of the web retractor 114 (FIG. 1C) so that movement of the web coupling 240 causes the shoulder web portion 121a to slide against the second web bearing surface 355b and the third web bearing surface 355c as the web coupling 240 pulls a loop of the shoulder web portion 121a downwardly toward the pretensioner 116.

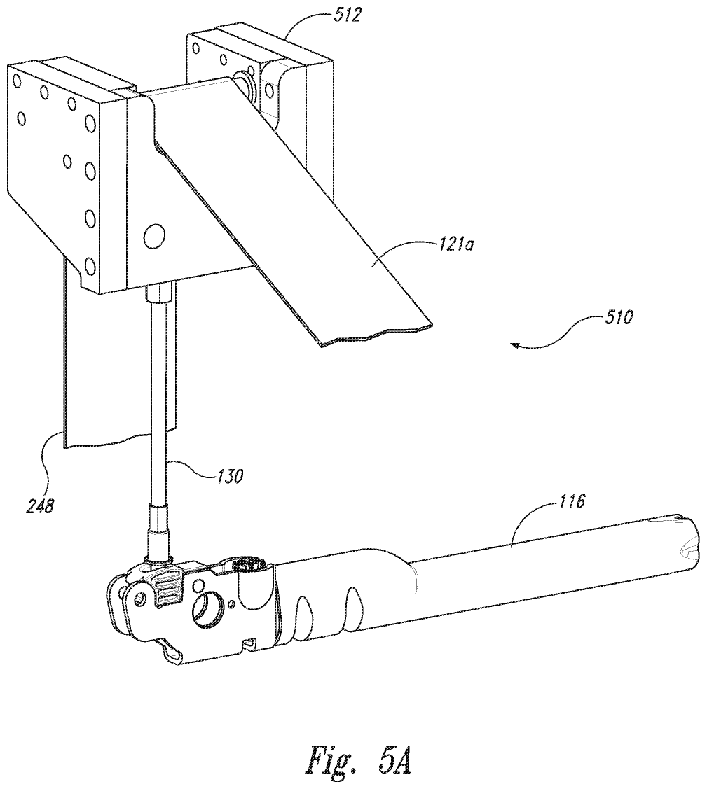

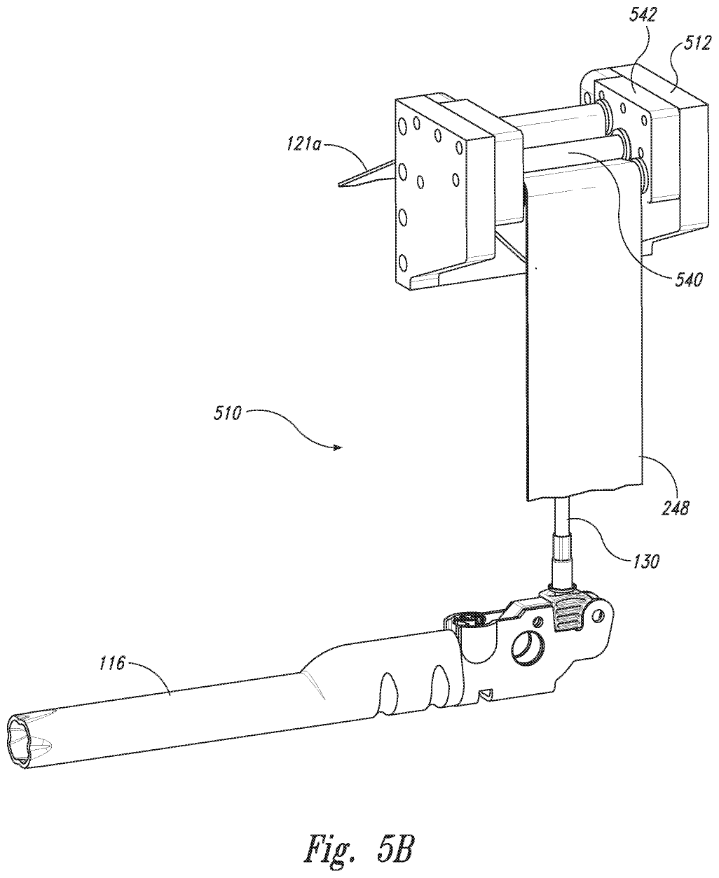

The pretension multiplier 112 described in detail above with reference to FIGS. 1A-4B is one example of a device configured in accordance with the present technology for increasing the amount of web that can be retracted by a given stroke of a pretensioner. Accordingly, in other embodiments, occupant restraint pretensioning systems can include other pretension multipliers configured in accordance with the present technology. For example, FIGS. 5A and 5B are partially schematic front and rear isometric views, respectively, of an occupant restraint pretensioning system 510 having a pretension multiplier 512 configured in accordance with another embodiment of the present technology. Referring to FIGS. 5A and 5B together, the pretension multiplier 512 includes a web guide 542 and a web coupling 540. The web coupling 540 is operably connected to the pretensioner 116 by means of a connecting member, such as the cable 130.

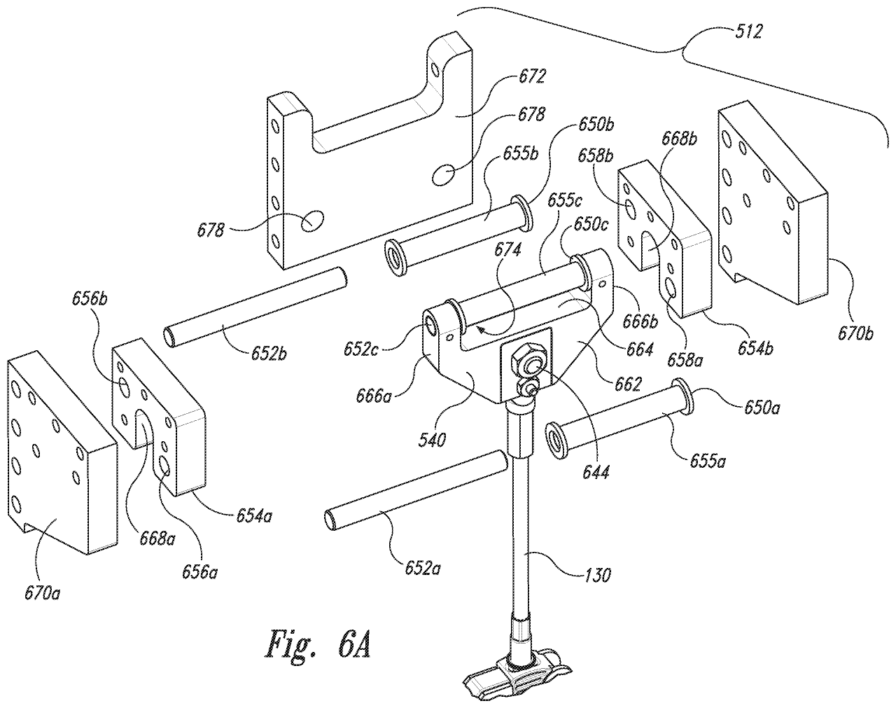

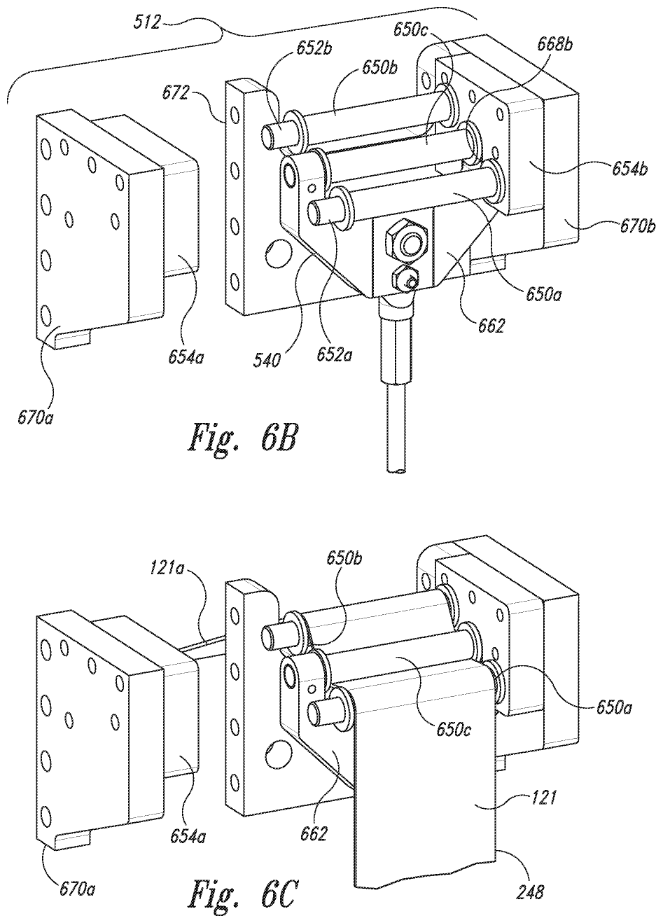

FIG. 6A is a partially exploded rear isometric view of the pretension multiplier 512 configured in accordance with some embodiments of the present technology, and FIGS. 6B and 6C are a series of partially assembled rear isometric views of the pretension multiplier 512. Referring first to FIG. 6A, in the illustrated embodiment the web guide 542 (FIG. 5B) includes a first guide member in the form of a first roller 650a, and a second guide member in the form of a second roller 650b. The first and second rollers 650a, b can be rotatably mounted to corresponding first and second shafts 652a, b, respectively, A first end portion of the first shaft 652a can be received in a corresponding first bore 656a in a first guide block 654a, and a second end portion of the first shaft 652a can be similarly received in a first bore 658a in a second guide block 654b. Similarly, a first end portion of the second shaft 652b can be received in a second bore 656b in the first guide block 654a, and a second end portion of the second shaft 652b can be received in a second bore 658b in the second guide block 654b. The first and second guide blocks 654a, b can be fixedly attached (by, e.g., one or more fasteners) to the inner faces of a first side wall 670a and a second side wall 670b, which are in turn fixedly attached along forward edge portions thereof to a front wall 672 (by, e.g., a plurality of suitable fasteners) as shown in, for example, FIGS. 6B and 6C. The front wall 672 can include one or more fastener openings 678 configured to receive suitable fasteners (e.g., bolts) for fixedly attaching the pretension multiplier 512 to the seat back portion 107 of the seat frame 106 as shown in FIGS. 1A and 1C.

Returning to FIG. 6A, in the illustrated embodiment, the web coupling 540 includes a yoke 662 that is fixedly attached to a distal end portion of the cable 130 by means of a suitable fastener 644 (e.g., a nut and bolt combination). Additionally, the web coupling 540 can further include a coupling member in the form of a third roller 650c that is rotatably mounted to the yoke 662 by means of a shaft 652c. The third roller 650c is offset from an upper edge portion 664 of the yoke 662 to define a gap or opening 674 therebetween through which the shoulder web portion 121a of the web 121 can pass when installed through the pretension multiplier 512 as shown in FIG. 6C.

In the illustrated embodiment, each of the guide blocks 654a, b includes an inverted slot or channel 668a, b configured to receive a corresponding edge portion 666a, b, respectively, of the yoke 662 as shown in, for example, FIG. 6B. The yoke 662 can be releasably held in the corresponding channels 668a, b prior to activation of the pretensioner 116 by means of, e.g., frangible pins or other suitable releasable fastening systems known in the art. Turning next to FIG. 6C, to install the web 121 on the pretension multiplier 512, the web 121 is extended over the first roller 650a, beneath the third roller 650c, and then over the second roller 650b.

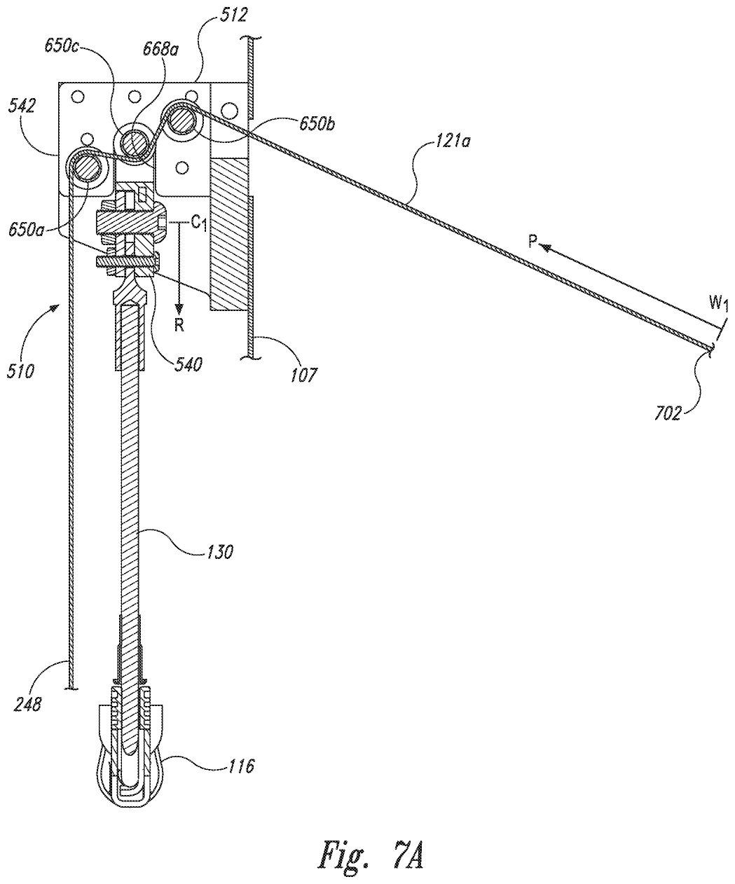

FIGS. 7A and 7B are side cross-sectional views illustrating the pretensioning system 510 in two states of operation, in accordance with some embodiments of the present technology. Referring first to FIG. 7A, prior to activation of the pretensioner 116, the web coupling 540 is retained in the slots 668a, b of the web guide 542 by, e.g., frangible pins or other suitable means. Starting from the end portion 248 of the web 121 that is coupled to the web retractor 114 (FIG. 1A), the web 121 extends over the first roller 650a, under the third roller 650c, and then over the second roller 650b before extending outwardly through the opening 128 in the upper portion of the seat 104 as shown in, for example, FIGS. 1A and 1B. In this configuration, the rollers 650a-c enable the web 121 to pass easily back and forth through the pretension multiplier 512 with relatively low friction.

When the pretensioner 116 is activated in response to, e.g., a rapid deceleration or other dynamic event above a preset threshold, the pretensioner 116 rapidly retracts the cable 130, thereby pulling the web coupling 540 in direction R through a first distance D₁ from a first coupling position C₁ to a second coupling position C₂, as shown in FIG. 7B. As the web coupling 540 moves downwardly through the first distance D₁, it draws a loop of the shoulder web portion 121a through the web guide 542. As shown in FIG. 7B, drawing the loop of web through the web guide 542 in this manner causes a reference point 702 on the shoulder web portion 121a to move in direction P from a first web position W₁ to a second web position W₂, through a second distance D₂. As a result of the web coupling 540 pulling a loop of the shoulder web portion 121a through the web guide 542, the retracted length of web represented by the second distance D₂ is substantially longer than the first distance D₁ traveled by the web coupling 540, which corresponds to the stroke of the pretensioner 116. For example, in some embodiments, the second distance D₂ can range from about 1.2 to about 2 times the first distance D₁, or from about 1.4 to about 1.9 times D₁. By way of another example, in some embodiments, the first distance D₁ can be about 3 inches, and the second distance D₂ can be about 5 inches. In other embodiments, pretension multipliers configured in accordance with the present technology can be configured and utilized to retract different lengths of restraint webs relative to corresponding movements (e.g., strokes) of pretensioners.

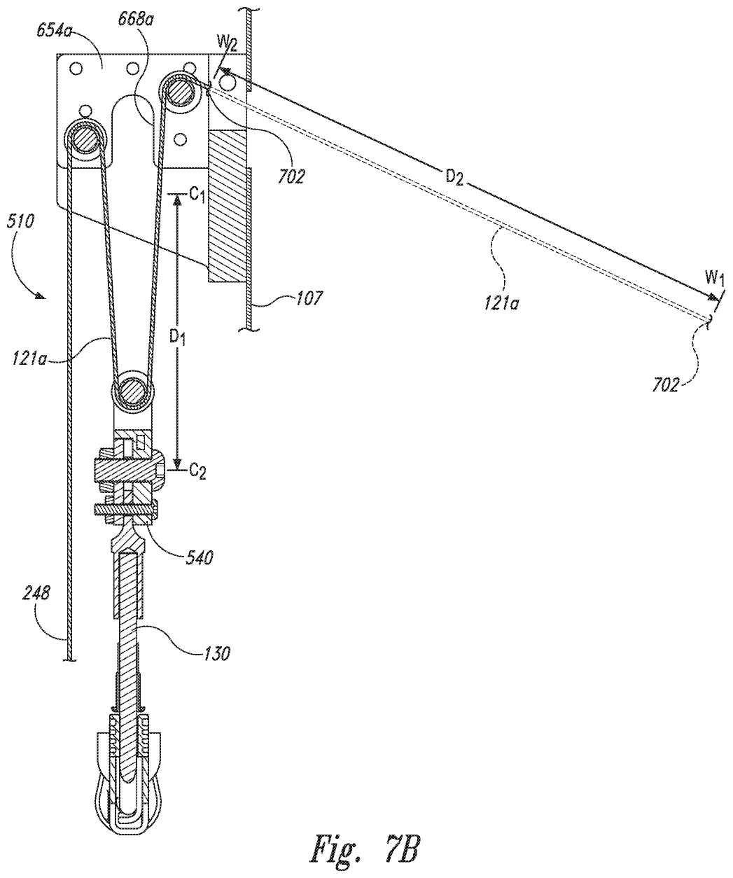

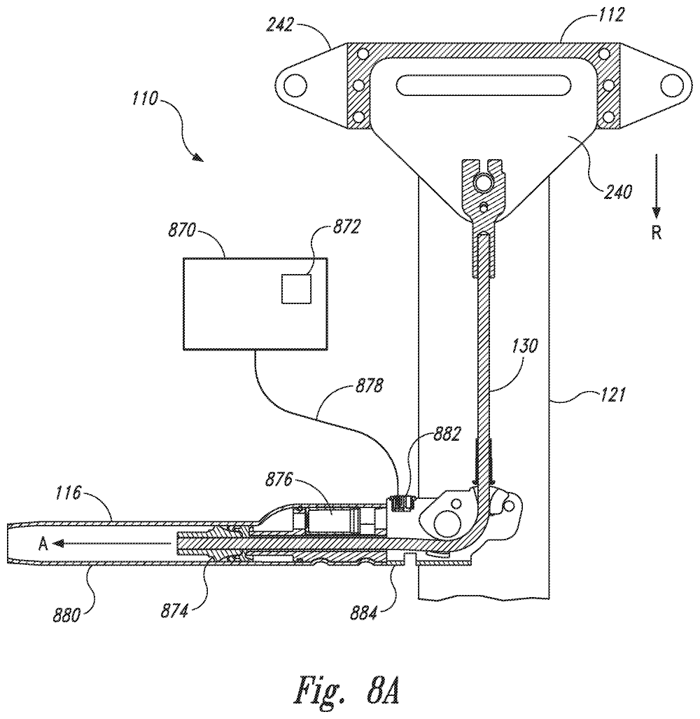

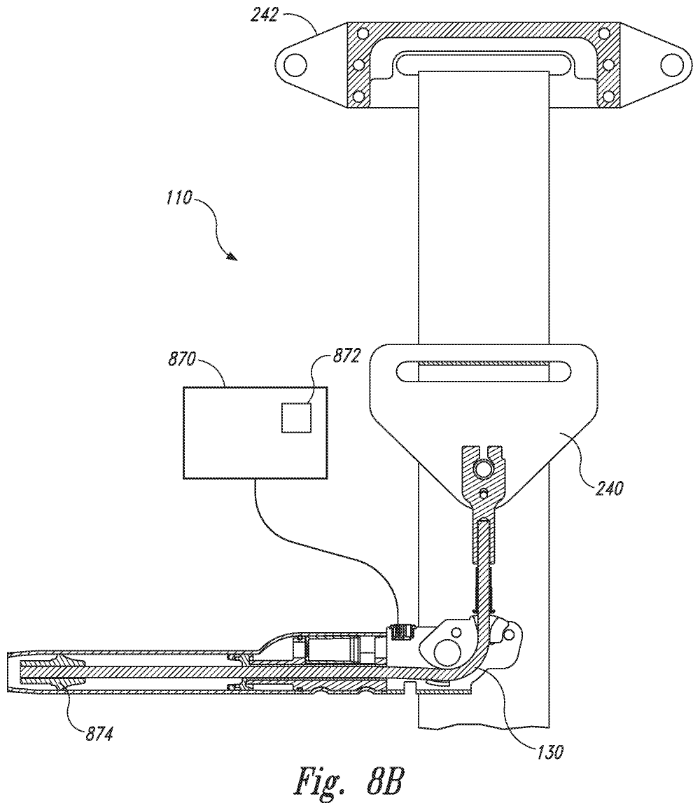

FIGS. 8A and 8B are partially schematic front views of the pretensioning system 110 illustrating the pretensioner 116 in cross-sectional view, in accordance with some embodiments of the present technology. Referring first to FIG. 8A, a proximal end portion of the cable 130 can be attached to a piston 874 that is slidably positioned in a cylinder 880 of the pretensioner 116 in a conventional manner. The pretensioner 116 can further include a gas generator 876 and an initiator 882. The gas generator 876 can be, for example, a pyrotechnic element that is activated by the initiator 882 in response to an electrical signal received from a sensor assembly 870 via an electrical link (e.g., one or more wires) 878. The sensor assembly 870 can include one or more sensors 872 (e.g., accelerometers) configured to detect rapid accelerations and/or decelerations above a preset magnitude. In operation, the sensors 872 can sense, for example, a rapid deceleration or other dynamic event above a preset magnitude (e.g., a deceleration greater than about 15 g's), and in response, the sensor assembly 870 can send a corresponding electrical signal to the initiator 882 via the link 878. In response, the initiator 882 activates the gas generator 876, which in turn generates combustion gases which rapidly increase the internal pressure within the cylinder 880 and drive the piston 874 in direction A, thereby pulling the cable 130 into the pretensioner housing 88 and moving the web coupling 240 downwardly toward the pretensioner 116 in direction R, as described in detail above and as shown in FIG. 8B.

In some embodiments, the pretensioner 116 can be configured to retract up to 4 inches of the cable 130, such as about 3 inches. In other embodiments, the pretensioner 116 can be configured to retract other lengths of the cable 130. Additionally, in some embodiments, the sensor assembly 870 can be configured to activate the pretensioner 116 in less than 50 milliseconds after the start of the acceleration and/or deceleration event sensed by the one or more sensors 872. For example, in some embodiments, the pretensioner activation time can be between about 37 milliseconds and about 47 milliseconds, or about 42 milliseconds. In yet other embodiments, the pretensioner retraction time, or the time it takes for the pretensioner 116 to retract the preset length of the cable 130 after activation, can be less than 15 milliseconds. For example, in some embodiments, the pretensioner retraction time can be between about 8 milliseconds and about 12 milliseconds, or about 10 milliseconds.

Although FIGS. 8A and 8B illustrate one suitable type of seat belt pretensioner (e.g., linear pretensioners) that can be used with pretension multipliers configured in accordance with the present technology, in other embodiments, pretension multipliers configured in accordance with the present technology can be used with other types of suitable pretensioning devices known in the art. Such pretensioners can include, for example, other suitable electrical, mechanical, pyrotechnic, pneumatic, hydraulic, and/or electromechanical seat belt pretensioning devices. Such devices can include, for example, rotary pretensioning devices. Accordingly, the pretension multipliers and other such devices described herein are not limited to use with any particular pretensioner device unless such limitation is expressly set forth herein.

Embodiments of the pretensioning systems described above can significantly reduce occupant forward head excursion by retracting the web 121 (FIG. 1A) more than conventional pretensioning systems before the occupant's body significantly loads the web 121 due to forward motion. In such embodiments, the web 121 is not significantly loaded by the occupant's body until after the web 121 has already been retracted by means of the pretensioning systems described herein. By way of example, in some embodiments, the pretension multipliers described herein can provide about 5 inches of web retraction for about 2.5 to 3 inches of web coupling travel. By reducing forward head excursion in the foregoing manner, the pretensioning systems of the present technology can enable airlines to position passenger seats closer together, thereby increasing efficiency. Additionally, some embodiments of the pretensioning systems of the present technology provide the additional benefits that they can be positioned inside the seat back of a passenger seat, they can be rapidly activated without any input from the occupant, and furthermore, they do not inhibit occupant egress from the seat before or after an activating event.

References throughout the foregoing description to features, advantages, or similar language do not imply that all of the features and advantages that may be realized with the present technology should be or are in any single embodiment of the invention. Rather, language referring to the features and advantages is understood to mean that a specific feature, advantage, or characteristic described in connection with an embodiment is included in at least one embodiment of the present technology. Thus, discussion of the features and advantages, and similar language, throughout this specification may, but do not necessarily, refer to the same embodiment. Furthermore, the described features, advantages, and characteristics of the present technology may be combined in any suitable manner in one or more embodiments. One skilled in the relevant art will recognize that the present technology can be practiced without one or more of the specific features or advantages of a particular embodiment. In other instances, additional features and advantages may be recognized in certain embodiments that may not be present in all embodiments of the present technology.

Any patents and applications and other references noted above, including any that may be listed in accompanying filing papers, are incorporated herein by reference in the entirety, except for any subject matter disclaimers or disavowals, and except to the extent that the incorporated material is inconsistent with the express disclosure herein, in which case the language in this disclosure controls. Aspects of the invention can be modified, if necessary, to employ the systems, functions, and concepts of the various references described above to provide yet further implementations of the invention.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples and embodiments of the invention is not intended to be exhaustive or to limit the invention to the precise form disclosed above. While specific examples for the invention are described above for illustrative purposes, various equivalent modifications are possible within the scope of the invention, as those skilled in the relevant art will recognize.

The teachings of the invention provided herein can be applied to other systems, not necessarily the system described above. The elements and acts of the various examples described above can be combined to provide further implementations of the invention. Some alternative implementations of the invention may include not only additional elements to those implementations noted above, but also may include fewer elements. Further any specific numbers noted herein are only examples: alternative implementations may employ differing values or ranges.

While the above description describes various embodiments of the invention and the best mode contemplated, regardless how detailed the above text, the invention can be practiced in many ways. Details of the system may vary considerably in its specific implementation, while still being encompassed by the present disclosure. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

From the foregoing, it will be appreciated that specific embodiments of the invention have been described herein for purposes of illustration, but that various modifications may be made without deviating from the spirit and scope of the various embodiments of the invention. Further, while various advantages associated with certain embodiments of the invention have been described above in the context of those embodiments, other embodiments may also exhibit such advantages, and not all embodiments need necessarily exhibit such advantages to fall within the scope of the invention. Accordingly, the invention is not limited, except as by the appended claims.

Although certain aspects of the invention are presented below in certain claim forms, the applicant contemplates the various aspects of the invention in any number of claim forms. Accordingly, the applicant reserves the right to pursue additional claims after filing this application to pursue such additional claim forms, in either this application or in a continuing application.

I/We claim:

1. A web pretensioning system for use with an occupant restraint system in an aircraft, the occupant restraint system having a web configured to extend across at least a portion of an occupant seated in an aircraft seat, the pretensioning system comprising:
a pretensioner; and
a pretension multiplier having—
a web guide configured to support the web; and
a web coupling configured to receive the web, wherein the web coupling is operably coupled to the pretensioner, and wherein operation of the pretensioner is configured to move the web coupling away from the web guide a first distance, thereby retracting a portion of the web through the web guide, the portion of the web having an overall length that is equal to a second distance, the second distance being greater than the first distance.

2. The web pretensioning system of claim 1 wherein the web guide includes a first web bearing surface and a second web bearing surface spaced apart from the first web bearing surface, wherein the web coupling includes a third web bearing surface positioned generally between the first and second web bearing surfaces, and wherein operation of the pretensioner is configured to move the third web bearing surface away from the first and second web bearing surfaces.

3. The web pretensioning system of claim 2 wherein the first and second web bearing surfaces are configured to bear against a first side of the web, and wherein the third web bearing surface is configured to bear against a second side of the web, opposite to the first side.

4. The web pretensioning system of claim 1 wherein the web guide includes a first guide member configured to operably support the web on a first side of the web coupling and a second guide member configured to operably support the web on a second side of the web coupling, opposite to the first side, and wherein operation of the pretensioner is configured to move the web coupling away from the first and second guide members, thereby pulling a loop of the web through the web guide.

5. The web pretensioning system of claim 4 wherein the first guide member includes a first roller configured to rotatably support the web on the first side of the web coupling and the second guide member includes a second roller configured to rotatably support the web on the second side of the web coupling.

6. The web pretensioning system of claim 1 wherein the pretensioner is a linear pretensioner having a cable operably connected to the web coupling, and wherein the linear pretensioner is configured to retract the cable the first distance in response to a dynamic event above a preset threshold to thereby move the web coupling away from the web guide the first distance.

7. The web pretensioning system of 1 claim wherein the web forms at east a portion of a three-point occupant restraint.

8. The web pretensioning system of claim 1 wherein the web forms at least a shoulder web portion of an occupant restraint, and wherein the pretension multiplier is configured to receive the shoulder web portion.

9. The web pretensioning system of claim 1 wherein the web forms at least a shoulder web portion of a three-point occupant restraint having an end portion operably coupled to a web retractor, and wherein the pretension multiplier is configured to receive the web between the shoulder web portion and the web retractor.

10. The web pretensioning system of claim 1 wherein the web forms at feast a shoulder web portion of an occupant restraint, the shoulder web extending proximate a seat back portion of the aircraft seat, and wherein the pretension multiplier is configured to be operably mounted to the seat back portion.

11. The web pretensioning system of claim 1 wherein the web is configured to extend from an anchor point positioned proximate a first portion of the aircraft seat to a web retractor positioned proximate a second portion of the aircraft seat, and wherein retracting the web through the web guide is configured to reduce an effective length of the web extending from the anchor point to the web retractor.

12. An occupant restraint system for use with a seat in an aircraft, the occupant restraint system comprising:
a web configured to extend across at least a portion of an occupant seated in the aircraft seat; and
a web pretensioning system including—
a web guide configured to movably support a portion of the web;
a web coupling having an initial position proximate the web guide, the web coupling having an opening configured to movably receive a portion of the web; and
an actuator operably attached to the web coupling, wherein operation of the actuator is configured to rapidly move the web coupling away from the web guide in response to a dynamic event, thereby pulling a loop of the web through the web guide to pretension the web and reduce forward movement of the occupant in response to the dynamic event.

13. The occupant restraint system of claim 12 wherein the actuator is configured to move the web coupling away from the web guide a distance in response to the dynamic event, and wherein the loop of web has an overall length that is greater than the distance.

14. The occupant restraint system of claim 13 wherein the overall length ranges from about 1.2 to about 2 times the distance.

15. The occupant restraint system of claim 12:
wherein the opening in the web coupling is a first opening,
wherein the web guide includes a second opening and a third opening,
wherein, when the web coupling is in the initial position, the second opening is configured to movably receive the web on a first side of the first opening and the third opening is configured to movably receive the web on a second side of the first opening, and
wherein operation of the actuator is configured to move the first opening away from the second and third openings, thereby pulling the web through at least the first opening.

16. The occupant restraint system of claim 15 wherein the first, second, and third openings are generally aligned when the web coupling is in the initial position.

17. The occupant restraint system of claim 12:
wherein the web coupling includes a first web bearing surface configured to contact a first side of the web,
wherein the web guide includes second and third web bearing surfaces configured to contact a second side of the web, opposite to the first side,
wherein the first web bearing surface is positioned generally between the second and third web bearing surfaces when the web coupling is in the initial position, and
wherein operation of the actuator is configured to move the first web bearing surface away from the second and third web bearing surfaces, thereby pulling the web across at least the first web bearing surface.

18. The occupant restraint system of claim 12 wherein the actuator includes a linear pretensioner.

19. A system for pretensioning an occupant restraint operably coupled to a seat in a vehicle, the seat having a seat base portion and a seat back portion, the occupant restraint including a lap web portion and a shoulder web portion, the system comprising:
means for slidably guiding the shoulder web portion proximate the seat back portion;
means for slidably coupling to the shoulder web portion proximate the seat back portion; and
means for rapidly moving the means for slidably coupling away from the means for slidably guiding a first distance, wherein rapidly moving the means for slidably coupling away from the means for slidably guiding the first distance retracts a length of the shoulder web portion, the length being equivalent to a second distance, the second distance being greater than the first distance.

20. The system of claim 19 wherein the means for slidably guiding and the means for rapidly moving are attached to the seat back portion.

21. The system of claim 19 wherein the means for rapidly moving includes a linear pretensioner having a connecting member operably coupled to the means for slidably coupling.
